(19) United States
(12) Patent Application Publication
(10) Pub. No.: US 2007/0248737 A1
(43) Pub. Date: Oct. 25, 2007

(54) Process for preparing a tea product

(75) Inventors: Sucheta Shrirang Kulkarni, Bangalore (IN); Navin Kumar Sharma, Hyderabad (IN); Guttapadu Sreeramulu, Bangalore (IN); Purna Venkatesh, Bangalore (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco Inc, d/b/a UNILEVER

(21) Appl. No.: 11/713,290

(22) Filed: Mar. 2, 2007

(30) Foreign Application Priority Data
Mar. 3, 2006 (IN) 306/MUM/2006
Jun. 1, 2006 (EP) EP06076144

(51) Int. Cl. A23F 3/00

(52) U.S. Cl. 426/597

(57) ABSTRACT

A process for preparing a tea product with an enhanced level of theanine is provided. The process comprises contacting tea leaf and/or shoot with a theanine precursor. The theanine precursor is contacted with the tea leaf and/or shoot during a withering step and/or at a pH in the range of 7 to 12.

### TECHNICAL FIELD OF THE INVENTION

The invention relates to a process for preparing a tea product. More particularly, the present invention relates to a process for enhancing the level of theanine in a tea product.

### BACKGROUND OF THE INVENTION

Many different tea products are prepared from the tea plant. Two of the more popular products are green leaf tea and black leaf tea. Generally, to prepare black leaf tea, fresh green leaves of the plant Camellia sinensis are withered (a process to allow the plucked tea leaves to lose moisture and bring about chemical/biochemical changes especially in aroma), macerated, fermented (in which process enzymes in the tea leaf use atmospheric oxygen to oxidise various substrates to produce coloured products) and then dried at higher temperatures (usually sufficient to arrest enzyme activity). Whereas, green tea is not exposed to the fermentation process and partial fermentation may be used to produce intermediate-type teas known as “oolong” tea.

Tea is consumed as a hot beverage or as a cold beverage (for example iced tea). The numerous compounds in the leaves that give the beverage its unique organoleptic properties are only sparingly soluble in cold water. Therefore tea is usually infused in water at temperatures close to 100° C. Cold water soluble teas are usually prepared by spray drying the liquor obtained by extraction of black tea or fibres generated during the black tea manufacturing process. Alternately many of the useful ingredients from tea e.g aroma compounds, polyphenols etc are extracted using various methods and concentrates are prepared for sale. Such concentrates may be added to other foods products to provide the benefits of tea in those products.

In the manufacture of black tea, young leaves usually 2-3 leaves and a bud are plucked and withered for about 12-24 hours to reduce moisture and to bring about desirable chemical/biochemical changes.

Withering allows certain chemical and biochemical changes to occur and also the moisture content of the leaves is brought down from a range of 80-90 wt % to a range of 35-70 wt %. Biochemical/chemical changes taking place during withering may also increase the yield of the volatile flavour compounds in tea.

At the end of withering period, the tea leaves are macerated using a cut-tear-and curl machine (CTC machine), other mechanical means or rolled using rollers and subjected to a process of fermentation and fired at a high temperature to stop the enzyme activity and give characteristic black colour. Disruption of cellular integrity of leaf tissues during the maceration process allows oxidation of catechins and fatty acids and hydrolysis of other substances by tea enzymes which results in the development of colour and aroma molecules.

The macerated tea is fermented and subsequently dried to bring down the moisture level of black tea to about 4-8%.

Theanine is a unique amino acid found in the highest concentrations in tea—Camellia sinensis within the plant kingdom. It is reported to stimulate α-waves in the mammalian brain and bestows a relaxed but alert feeling to the individual. The physiological effects on humans mentioned above happen only when a certain dosage is consumed. Very few teas currently can deliver this minimum dosage. Hence there is a current general interest in increasing the levels of theanine in the teas. The content of theanine varies in the geographical areas as well as from plant to plant. The theanine content has been reported not to change significantly in the processes of withering and during the general manufacturing of tea.

In the tea plant the theanine content is highest in the roots followed by the uppermost shoot. Literature indicates that in the tea plant, theanine is synthesized in roots and transported to the shoots. Generally, two leaf and a bud or three leaf and a bud are used for tea making.

JP 2004-168686 describes a method for improving the amino acid composition in tea leaves and especially improving the content of theanine by spraying at last one amino acid selected from theanine, glutamine and glutamic acid in an amino acid concentration of 10 to 1000 ppm on the surfaces of tea leaves, just before the tea leaves are harvested.

JP 58-170703 describes a method of treating tea plant during its growth by applying a solution of monoethanol amine and/or mono methylamine and amino acid solutions to leaf surfaces of tea trees in the period from emergence to plucking to form theanine (glutamic acid ethylamide) and glutamine acid methyl amide.

Although some reports of forming higher levels of theanine in tea leaves have been reported as summarized above, it is desirable to develop further improved methods of producing tea with enhanced levels of theanine. Further, the known methods of enhancing theanine involve treating tea leaves on the plant during its growth. The present inventors have surprisingly found during the course of extensive research, that the tea leaf/shoots may be treated after harvesting and specifically during the withering step of the tea processing, to form enhanced amounts of theanine.

It is thus an object of the present invention to develop a method to produce a tea product containing enhanced levels of theanine.

It is another object of the present invention to develop a method to produce black tea with high levels of theanine.

It is yet another object of the present invention to develop a method to produce a tea product with enhanced theanine from the leaf of the tea plant whilst avoiding the inconvenience and waste of spraying a whole, growing plant.

It is yet another object of the present invention to develop a method to produce a tea product with enhanced levels of theanine from the stem of the tea plant.

### SUMMARY OF THE INVENTION

According to one aspect of the present invention, there is provided a process for preparing a tea product with an enhanced level of theanine, comprising contacting tea leaf and/or shoots with a theanine precursor during a withering step.

Preferably the theanine precursor is selected from glutamic acid, L-glutamine, L-alanine, ethylamine, ethylamine hydrochloride, pyruvic acid, pyruvate, α-keto glutaric acid, 5-oxo-glutarate, acetaldehyde or a mixture thereof.

It is particularly preferred that the tea leaf/shoots is contacted with said theanine precursors at a pH between 7 and 12.

According to another aspect of the present invention there is provided a process for preparing a tea product with an enhanced level of theanine comprising contacting tea leaf and/or shoots with the theanine precursor at a pH between 7 and 12. In this aspect, the tea leaf and/or shoot may be contacted with the theanine precursor prior to harvesting.

### DETAILED DESCRIPTION OF THE INVENTION

“Tea” for the purposes of the present invention means leaf material from Camellia sinensis var. sinensis or Camellia sinensis var. assamica. It also includes rooibos tea obtained from Aspalathus. “Tea” is also intended to include the product of blending two or more of any of these teas.

“Leaf tea” for the purposes of this invention means a tea product that contains one or more tea origins in an uninfused form. “Tea shoots” means tea leaves as plucked and usually contains two leaves and a bud or three leaves and a bud with or without the interbud and the stem.

A “tea product” as per this invention is a product prepared from the tea plant and includes black tea, green tea, oolong tea, cold water soluble tea, and any extract or concentrate prepared from the tea plant. A particularly preferred tea product is black tea.

Tea manufacture, especially black tea manufacture, traditionally comprises the following steps: withering, macerating, fermenting and firing or drying.

Withering is a process whereby the plucked tea leaves are stored for periods of time (preferably between 1 and 24 hours), during which they undergo various biochemical and physical changes which often includes a loss of moisture.

Maceration follows the withering step, and traditionally the withered leaves are rolled to bruise and crush the leaves i.e. break down the plant tissue structure. This has the effect of liberating fermentable substrates and fermenting enzymes from within the plant cells and tissue. Modern tea manufacture usually includes this step however this is achieved by passing tea, which has been withered, through a cutting machine. Thus for the purpose of the invention the tea leaves may be macerated using a CTC, ball mill or a grinder or a hammer mill or a Lawri tea processor or a Legg cutting machine or rolled using tea rollers as in orthodox tea processing.

The next step is commonly called fermentation but that is a misnomer. “Fermentation” is commonly used in the context of brewing alcohol to describe the action of exogenous enzymes. However in the case of tea it is used to refer to the oxidative and hydrolytic process that tea undergoes when certain endogenous enzymes and substrates are brought together by mechanical disruption of the cells by maceration of the leaves. During this process colourless catechins in the leaves are converted to a complex mixture of yellow and orange to dark-brown substances and producing a large number of aromatic volatile compounds.

The fermented product is fired and dried to give black tea. The firing involves heating and drying the fermented tea to destroy the fermenting enzymes and thereby arrest fermentation. It results in a reduction of moisture content to below 5%, and also leads to further chemical oxidation of tea and changes in tea aroma. This generally involves exposing the tea to a blast of hot, dry air in a dryer.

Unless specified otherwise, the weight of tea leaf and/or shoots herein is on “as such” basis i.e weight of tea leaf and/or shoots on the plant or after harvesting and containing the natural amount of water present therein. Fresh tea leaf usually contains 80 to 90% moisture.

However, the theanine content of the tea leaves is expressed herein on a dry weight basis i.e. weight of theanine divided by the total dry weight of tea.

The process of the invention may be carried out on tea leaf and/or shoots. One aspect of the invention relates to preparing black tea with enhanced theanine comprising the step of contacting tea leaf and/or shoots with a theanine precursor during the withering step of black tea manufacture. The step of contacting tea leaf/shoots with said theanine precursor is preferably carried out at a pH between 7 and 12.

According to another aspect of the invention the tea leaf/shoots may be contacted with the theanine precursor before the leaf and/or shoots are harvested from the plant, the contact occuring at a pH between 7 and 12.

Of the two aspects, the former is preferred i.e. the leaf and/or shoots are contacted with the theanine precursor after they are harvested and during withering. Contacting the tea leaf/shoots with the theanine precursor during the withering stage has added advantage in that it is possible to ensure better mixing of the tea leaf/shoots with the theanine under controlled processing conditions like temperature, humidity etc as are prevalent in a factory as compared to those prevalent in the tea plantation. Further the wastages of the theanine precursor that occurs during contacting by e.g spraying of the reagents in the plantations can be minimized. It is preferred that the tea leaf/shoots after contact with the theanine precursor during the withering stage is then passed through the conventional process of black tea manufacture i.e. maceration, fermentation and drying.

The theanine precursors, as per the invention, are preferably selected from glutamic acid, L-glutamine, L-alanine, ethylamine, ethylamine hydrochloride, pyruvic acid, pyruvate, α-keto glutaric acid, 5-oxo-glutarate or acetaldehyde. Highly preferred theanine precursors are glutamic acid, L-glutamine, L-alanine, ethylamine or ethylamine hydrochloride, most preferred being L-glutamine or L-alanine. The amount of theanine precursor depends on the specific compound used but is usually in the range of 0.1 to 20 millimoles per kg of tea leaf/shoots used, more preferably 0.25 to 10 millimoles of tea leaf/shoots used. The theanine precursor is usually dissolved in water and sprayed on to the leaf/shoots.

The invention provides for contacting the tea leaf/shoots with the theanine precursor during withering, preferably at a pH between 7 and 12, more preferably between 8.5 and 11. The pH is achieved using an appropriate amount of alkaline material preferably alkali metal carbonate, bicarbonate, phosphate, borate or with an organic alkali like tris (hydroxymethyl) amino methane, more preferably sodium salts of carbonate, bicarbonate or borate. The amount of alkaline material depends on the compound in order to achieve the pH desired, but is generally in the range of 0.0005 to 0.2% by weight of the tea leaf/shoots processed.

### EXAMPLE

### Examples 1-5

### Effect of Contacting Tea with Theanine Precursors During the Withering Stage

### Example 1

A 1 kg batch of tea leaves having a theanine content of 0.76 wt % (on dry weight basis) was taken and 2.5 millimoles of L-Glutamine in a water solution was sprayed on the tea leaves during the withering step. The spraying was done one hour after the leaves were harvested. The withering was continued for a period of 18 hours, followed by maceration which consisted of 4 CTCs (Crush, Tear and Curl) cuts followed by one hour of fermentation. The fermented tea was then dried to about 5% moisture. The theanine content of the black tea, thus produced was determined using the following standard procedure.

Analysis of Theanine content:

1 g of the tea was pulverized using a liquid nitrogen pulverizer. The powder thus obtained was extracted in hot water (minimum 60° C.). All extractions were done under constant conditions of water temperature, infusion time, agitation and water:tea ratio. The extract was cooled to about 30° C. The cooled extract was filtered and the theanine content in the filtrate was estimated using High Performance Liquid Chromatography (HPLC). A Lichrosper RP C18 column was used in a HPLC of Shimadzu make. The HPLC utilizes a post-derivatisation method using a fluorescence detector.

### Example 2

An experiment was carried out as per Example-1 except that 5 millimoles of L-Glutamine was used instead of 2.5 millimoles of L-Glutamine.

### Example 3

An experiment was carried out as per Example-1 except that 1 millimole of L-Glutamic acid and 1.25 millimoles of L-alanine was used instead of 2.5 millimoles of L-Glutamine and the freshly harvested tea leaves had a theanine content of 0.65 wt %.

### Example 4

An experiment was carried out as per Example-3 except that 1 millimole of L-Glutamic acid and 5 millimoles of ethylamine were used instead of 1 millimole of L-Glutamic acid and 1.25 millimoles of L-alanine.

### Example 5

An experiment was carried out as per Example-3 except that 1 millimole of L-Glutamic acid and 5 millimoles of ethylamine hydrochloride were used instead of 1 millimole of L-Glutamic acid and 1.25 millimoles of L-alanine.

The theanine content of the black tea, thus produced for Example 1 to 5 was determined using the standard procedure described above. The data are summarized in Table-1.

TABLE 1

| | | | Theanine |
|---|---|---|---|
| | | Theanine | content in |
| | 1 kg Tea | content | freshly |
| | contacted | in black | harvested tea |
| Example | with | tea (wt %) | leaves (wt %) |
| 1 | 2.5 mM of L-Glutamine | 1.41 | 0.76 |
| 2 | 5 mM of L-Glutamine | 1.19 | 0.76 |
| 3 | 1.25 mM of Glutamic Acid + | 0.73 | 0.65 |
| | 1.25 millimoles of | | |
| | L-alanine | | |
| 4 | 1 mM of Glutamic Acid + | 0.82 | 0.65 |
| | 5 mM of Ethylamine | | |
| 5 | 1 mM of Glutamic Acid + | 0.90 | 0.65 |
| | 5 mM of Ethylamine | | |
| | Hydrochloride | | |

The data in Table-1 indicates that black tea with enhanced levels of theanine can be produced by contacting tea during the withering step with theanine precursor.

### Examples 6-12

Effect of pH of the theanine precursors on theanine levels

1 kg of freshly plucked tea leaves were contacted with theanine precursors as shown in Table-2 at various pH conditions during the withering stage, one hour after the leaves were harvested. The theanine content of the freshly harvested tea leaves was 0.51 wt %. The withering was continued for 18 hours, followed by maceration which consisted of 4 CTCs (Crush, Tear and Curl) cuts followed by one hour of fermentation. The fermented tea was then dried to about 5% moisture. The theanine content of the black tea, thus produced was determined using the standard procedure described hereinbefore.

TABLE 2

| | | pH of | | |
|---|---|---|---|---|
| | 1 kg tea | theanine | Buffer | |
| Ex. | contacted | precursor | used to | Theanine |
| No | with | solution | achieve pH | (wt %) |
| | Control tea | | | 0.51 |
| | leaves as such | | | |
| | before treatment | | | |
| 6 | 2.5 mN of | 4.5 | Citric acid + | 0.51 |
| | L-Glutamine | | sodium citrate | |
| 7 | 0.25 mM of | 4.5 | Citric acid + | 0.51 |
| | Alanine | | sodium citrate | |
| 8 | 2.5 mM of | 7.5 | Tris-HC1 | 0.77 |
| | L-Glutamine + | | | |
| | mM of Alanine | | | |
| 9 | 2.5 mM of | 8.5 | Tris-HC1 | 0.88 |
| | L-Glutamine + | | | |
| | 0.25 mM | | | |
| | of Alanine | | | |
| 10 | 2.5 mM of | 9.5 | Sodium | 0.98 |
| | L-Glutamine + | | carbonate/ | |
| | .025 mM | | bicarbonate | |
| | of Alanine | | | |
| 11 | 2.5 mM of | 10.5 | Sodium | 1.08 |
| | L-Glutamine + | | carbonate/ | |
| | 0.25 mM | | bicarbonate | |
| | of Alanine | | | |
| 12 | 2.5 mM of | 11.5 | Sodium | 0.94 |
| | L-Glutamine + | | carbonate/ | |
| | 0.25 mM | | bicarbonate | |
| | of Alanine | | | |

Tris-HC1: tris-(hydroxyl methyl) amino methane + hydrochloric acid

The data in Table-2 indicates that enhanced levels of theanine in tea can be prepared by a process comprising contacting tea leaves during the withering step with theanine precursors at a pH between 7 and 12.

### Examples 13-15

Synergistic benefit of use of combination of theanine precursors

1 kg of freshly plucked tea leaves were contacted with theanine precursors as shown in Table-3 at a pH of 10 during the withering stage, one hour after the leaves were harvested. The theanine content of the freshly harvested tea leaves was 0.17wt %. The rest of the process of preparing black tea was as described in Examples 6-12. The theanine content of the black tea samples, thus produced was determined using the standard procedure described hereinbefore.

TABLE 3

| | | Theanine |
|---|---|---|
| | | content of |
| Ex. | | black tea |
| No | 1 kg tea contacted with | (wt %) |
| | Control tea leaves as | 0.17 |
| | such before treatment | |
| 13 | 2.5 mM of L-Glutamic Acid | 0.27 |
| 14 | 0.25 mM of Alanine | 0.22 |
| 15 | 2.5 mM of L-Glutamic + | 0.72 |
| | 2.5 mM of Alanine | |

The data in Table-3 indicates that a combination of theanine precursors when contacted with tea leaves during the withering step provides for synergistic effect in enhancing the theanine content in black tea.

### Examples 16-19

Use of stem for preparing tea product with enhanced theanine.

Tea leaves were contacted with 2.5 mM of L-Glutamine and 0.25 mM of Alanine at various pH conditions. The tea shoots were cut after this contact. The leaves were separated from the stem and the theanine content of the stem was measured. The theanine content of control stem without this additional contact with the theanine precursors was also measured. The theanine content of the stem samples separated from the shoots after withering was determined using the standard procedure described hereinbefore and is summarized in Table-4.

TABLE 4

| | | % Theanine | % Theanine |
|---|---|---|---|
| Ex. | pH condition | content in | after |
| No | of contact | control | treatment |
| 16 | 4.5 | 1.98 | 1.29 |
| 17 | 7.0 | 1.36 | 2.09 |
| 18 | 7.5 | 1.45 | 2.25 |
| 19 | 9.5 | 1.23 | 2.82 |

The data in Table-4 indicates that a tea product with enhanced levels of theanine can be produced by treating the tea stem with theanine precursors at an alkaline pH.

The invention thus provides for a method to produce a tea product especially black tea with theanine at higher levels as compared to methods known in the past. The invention also provides for a method to achieve this from the stem of the tea plant.

1. A process for preparing a tea product with an enhanced level of theanine comprising contacting tea leaf and/or shoot with a theanine precursor during a withering step.

2. A process according to claim 1 wherein the tea leaf and/or shoot is contacted with the theanine precursor at a pH between 7 and 12.

3. A process for preparing a tea product with an enhanced level of theanine comprising contacting tea leaf and/or shoot with a theanine precursor at a pH between 7 and 12.0.

4. A process according to claim 3 wherein the tea leaf and/or shoot is contacted with the theanine precursor prior to harvesting.

5. A process according to any one of the preceding claims wherein the tea product is black tea.

6. A process according to claim 5 wherein the black tea is prepared by the conventional process of withering, maceration, fermentation and drying.

7. A process according to any one of claims 2 to 6 wherein the pH at which the tea leaf and/or shoot is contacted with theanine precursor is between 8.5 and 11.

8. A process according to any on of claims 2 to 7 wherein the pH at which the tea leaf and/or shoot is contacted with theanine precursor is achieved using an alkaline material selected from alkali metal salts of carbonate, bicarbonate, phosphate, borate or an organic alkali.

9. A process according to claim 8 wherein the organic alkali is tris (hydroxyl methyl) amino methane.

10. A process according to any one of the preceding claims wherein the theanine precursor is contacted with the tea leaf and/or shoot in an amount in the range of 0.1 to 20 millimoles per kg of tea leaf and shoot.

11. A process according to claim 10 wherein the theanine precursor is contacted with the tea leaf and/or shoot in an amount in the range of 0.25 to 10 millimoles per kg of tea leaf and shoot.

12. A process according to any one of the preceding claims wherein the theanine precursor is glutamic acid, L-glutamine, L-alanine, ethylamine, ethylamine hydrochloride, pyruvic acid, pyruvate, α-keto glutaric acid, 5-oxo-glutarate, acetaldehyde, or a mixture thereof.

13. A process according to claim 12 wherein the theanine precursor is glutamic acid, L-glutamine, L-alanine, ethylamine, ethylamine hydrochloride, or a mixture thereof.

14. A process according to claim 13 wherein the theanine precursor is L-glutamine, L-alanine, or a mixture thereof.
